(19) United States
(12) Patent Application Publication
(10) Pub. No.: US 2026/0028063 A1
(43) Pub. Date: Jan. 29, 2026

(54) VEHICLE FRONT TRUNK DOOR WITH A CLOSING VELOCITY IMPROVEMENT SYSTEM

(71) Applicant: FCA US LLC, Auburn Hills, MI (US)

(72) Inventors: Vivek V Kirtane, Auburn Hills, MI (US); Michael E LeFleur, Auburn Hills, MI (US)

(21) Appl. No.: 18/781,111

(22) Filed: Jul. 23, 2024

(51) Int. Cl. B62D 25/12; B60J 10/84; B60R 5/02; B62D 29/00

(52) U.S. Cl. CPC B62D 25/12; B60J 10/84; B60R 5/02; B62D 29/001

(57) ABSTRACT

A vehicle includes a front trunk bin having walls. The walls have an upper edge. A front trunk door has an outer surface and an inner surface. A seal is disposed between the front trunk door and the upper edge of the front trunk bin. The outer surface and the inner surface have an air passage therebetween. The air passage has an inlet disposed within the front trunk and an outlet disposed within the front trunk door.

### FIELD

The present disclosure relates generally to an electric vehicles and, more specifically, to a front trunk door with ventilation to improve closing velocity.

### BACKGROUND

This section provides background information related to the present disclosure which is not necessarily prior art.

Electric vehicles do not have an internal combustion engine. Internal combustion engines are typically located in the front of the vehicle underneath a hood. Often times, auto manufacturers use the space previously occupied in the front of the electric vehicle to house a storage bin or storage area that is referred to as front trunk or frunk. The front trunk has a door that is sometimes referred to as a hood in much the same way as in an internal combustion engine vehicle. Typically, the front trunk has a seal between the door and the storage bin to prevent outside elements from entering the storage pin. However, when closing the hood, the seal prevents air from leaving the frunk and increases the closing pressure an velocity to allow the frunk door to close and seal.

### SUMMARY

This section provides a general summary of the disclosure, and is not a comprehensive disclosure of its full scope or all of its features.

In one aspect of the disclosure, a vehicle includes a front trunk bin having walls. The walls have an upper edge. A front trunk door has an outer surface and an inner surface. A seal is disposed between the front trunk door and the upper edge of the front trunk bin. The outer surface and the inner surface have an air passage therebetween. The air passage has an inlet disposed within the front trunk and an outlet disposed within the front trunk door.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a perspective view of a vehicle having a closing velocity improvement system.

FIG. 1B is a front view of a frunk bin relative to a hood of the vehicle of FIG. 1A.

FIG. 2A is an underside view of the hood of FIG. 1A.

FIGS. 2B and 2C are cross-sectional views of the air passage formed within the hood of FIGS. 1A, 1B and 2A.

FIG. 3A is a perspective view of an alternative example of a vehicle with a closing velocity improvement system.

FIG. 3B is a front view of the frunk bin positioned relative to the hood of FIG. 3A.

FIG. 4A is the underside view of the hood of FIGS. 3A and 3B.

FIGS. 4B and 4C are cross-sectional views of the air passage within the hood of FIGS. 3A-4.

### DETAILED DESCRIPTION

Example embodiments will now be described more fully with reference to the accompanying drawings.

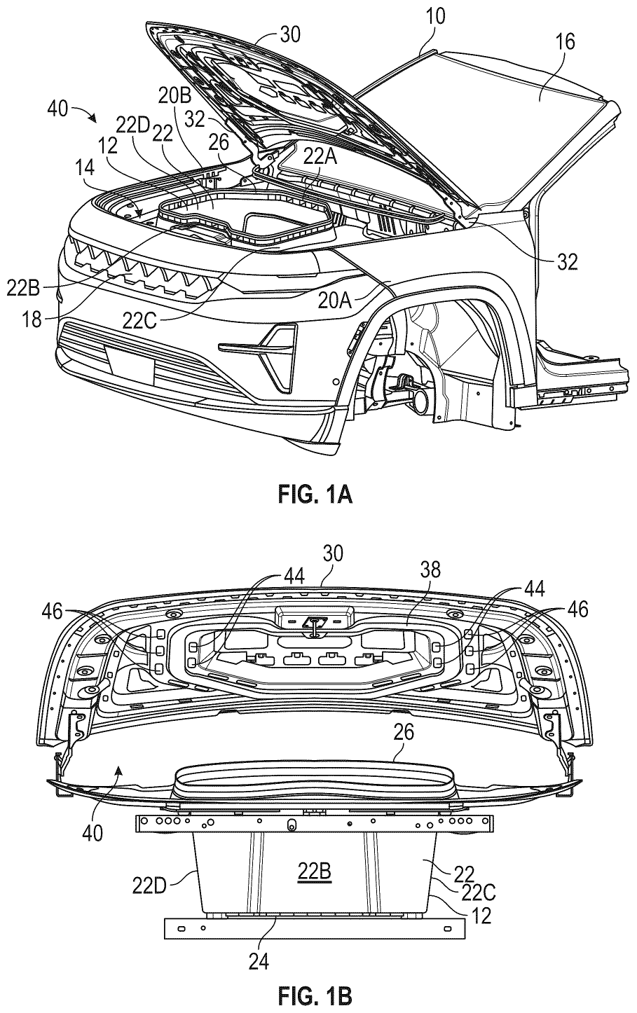

Referring now to FIG. 1, a vehicle 10 or front portion thereof is illustrated. In this example, a front trunk bin 12 is disposed in a front volume 14. The front volume 14 is front of the windshield 16 and the behind the front fascia 18 and between sides 20A and 20B of the vehicle. The bin 12 may have various shapes and sizes depending on the configuration of the vehicle. The bin 12 has vertically extending walls 22 that form the perimeter of the bin 12. The bin 12 also has floor 24. The bin 12 may be formed of various materials including plastic, metal or various component materials. The walls 22 in the present example are generally laterally extending walls 22A, 22B and longitudinal extending walls 22C and 22D. The walls 22A-22D may collectively be referred to as walls 22. The walls 22 are generally vertically extending and have a seal 26 extending therearound. The seal 26 may be a continuous rubberized material fastened to or affixed to an upper edge 28 of the walls 22.

A door 30 is used to enclose the front of the vehicle 10 and the bin 12. The door 30 provides a sealing surface 38 sealing with the seal 26. A hinge 32 is coupled to the vehicle sides 20A, 20B to allow the door 30 to rotate therefrom.

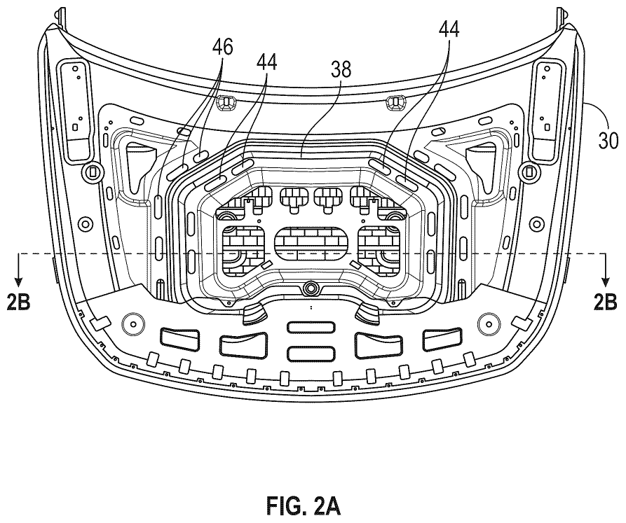

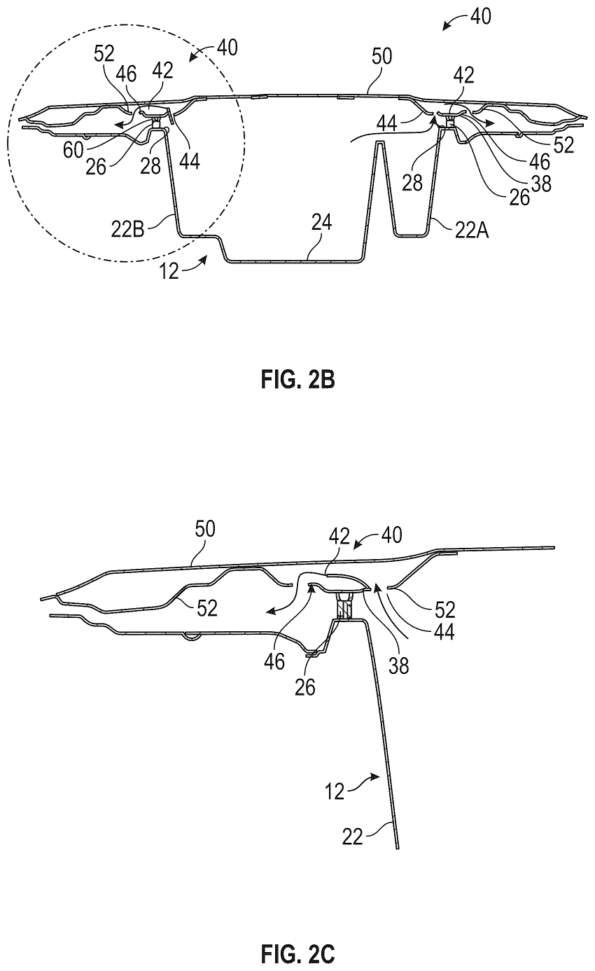

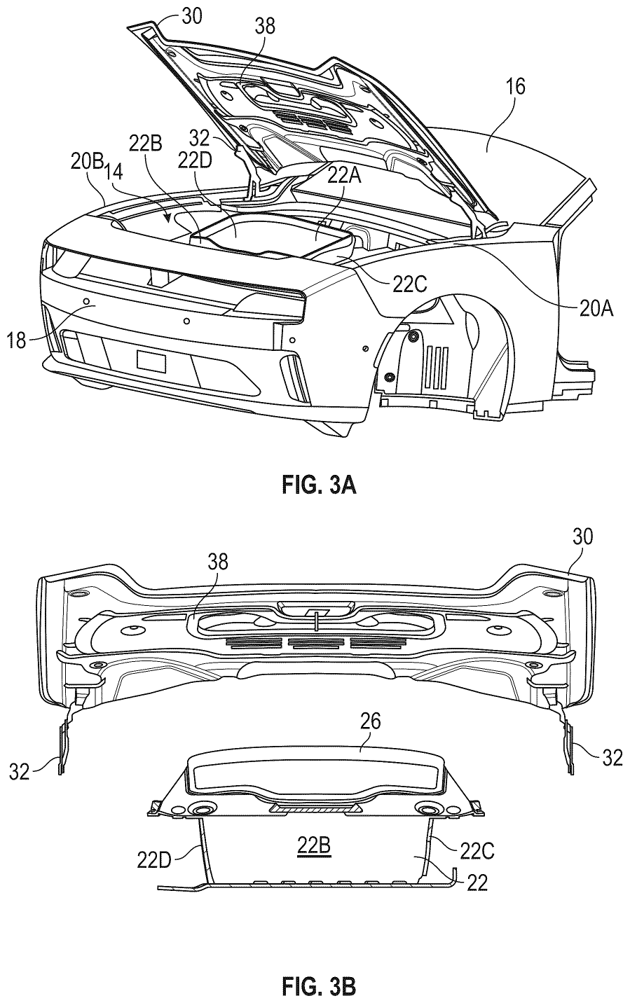

Referring now also to FIGS. 2A-2C, details of the closing velocity improvement system 40 are set forth. The closing velocity improvement system allows ventilation of air within the front trunk bin 12 to be ventilated outside of the front trunk bin during closing. In this example, air passages 42 are used for communicating air from within the front trunk bin 12 to outside the outside the front trunk bin 12. The air passages 42 have an inlet 44 disposed within the trunk bin 12 in an outlet 46 disposed outside of the trunk bin 12.

The air passages 42 are formed between two surfaces. In this example, the door 30 has an outer surface 50 and an inner surface 52. The outer surface 50 is a finished surface. In this example, the outer surface 50 and the inner surface 52 may be formed of the same material such as a metal. The outer surface 50 and the inner surface 52 may be secured by welding or other types of fasteners. The outer surface 50 and inner surface 52 may be electro-coated (e-coated) during the manufacturing process. One advantage of the system is that the inside and outside of the air passages 42 may be e-coated and the inlets 44 and the outlets 46 may allow excess e-coating material to drain from the air passages 42. There may be multiple paths or air passages 42 between the plurality of inlets 44 and the plurality of outlets 46 illustrated in FIG. 2A. The air passage 42 on each lateral side of the door 30 may be interconnected. That is, the inlets 44 and the outlets 46 may have a common air passage 42 therebetween on each lateral side of the door 30. The air passages 42 in this example are laterally generally laterally disposed relative to the vehicle 10.

The sealing surface 38 is disposed between the inlets 44 and the outlets 46. The sealing surface 38 may be a smooth surface that is disposed against the seal 26 when the door 30 is in a closed position as illustrated in FIGS. 2B and 2C. The seal 26 rests against the sealing surface 38 of the inner surface 52.

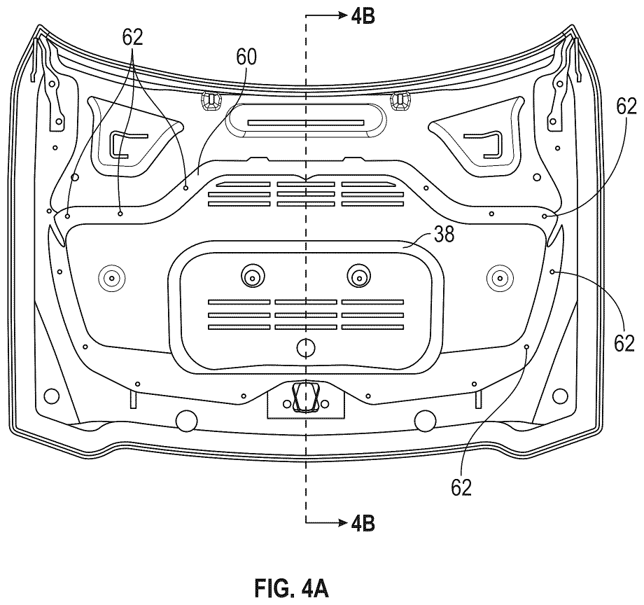

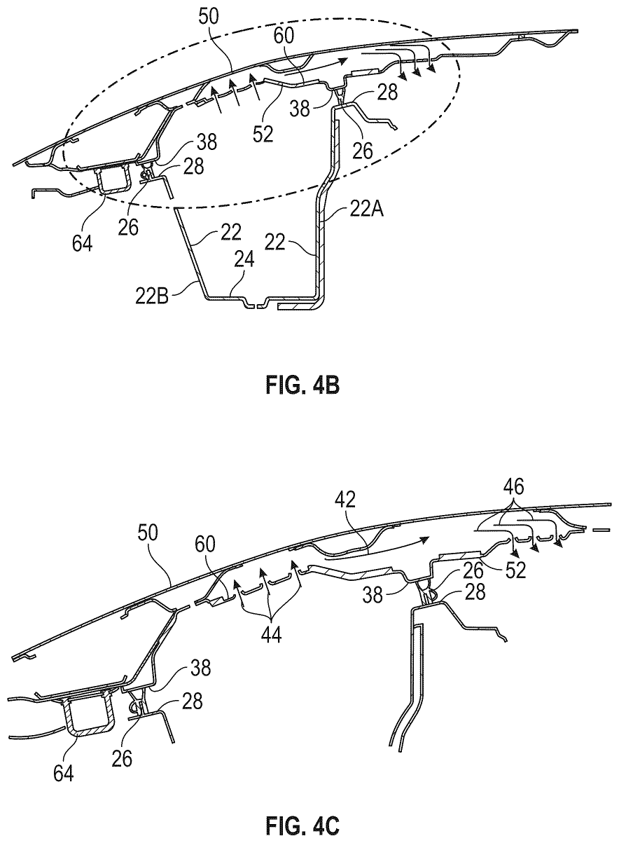

Referring now to FIGS. 4A-4C, a similar configuration labeled with the same reference numerals is illustrated. In this example unitary structure 60 is formed. The unitary structure 60 may be formed of a plastic, composite material or a material different than the outer surface 50. The unitary structure 60 may include the inlets 44, the outlets 46 and the lower half of the passages 42. Fasteners 62 may be used to secure the unitary structure to the outer surface 50. The passages 42 are disposed longitudinally relative to the vehicle 10. The inlets 44 and the outlets 46 in this example are elongated and laterally disposed relative to the vehicle 10.

During operation, when the door 30 is placed into the closed position, the sealing surface 38 seals against the seal 26. Air from within the front trunk bin 12 leaves the front trunk bin 12 through the inlet 44, the air passages 42 and the outlet 46. The air passages allow air to pass above the seal 26 relative to the position within the vehicle 10. When closed, the door 30 latches at a latch 64 that is illustrated in FIGS. 4B and 4C. However, a latch 64 may also be incorporated into the examples in FIGS. 2A-2C.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “they”” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be taken.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
a front trunk bin having walls, said walls comprising an upper edge;
a front trunk door comprising an outer surface and an inner surface;
a seal disposed between the front trunk door and the upper edge of the front trunk bin;
said outer surface and said inner surface comprising an air passage therebetween, said air passage comprising an inlet disposed within the front trunk and an outlet disposed within the front trunk door.

2. The vehicle of claim 1 wherein the air passage is above the seal.

3. The vehicle of claim 1 wherein the inner surface comprises a sealing surface disposed adjacent to the seal.

4. The vehicle of claim 3 wherein the seal is affixed to the upper edge of the front trunk bin.

5. The vehicle of claim 1 wherein the air passage comprises a plurality of air passages.

6. The vehicle of claim 5 wherein the plurality of air passages wherein each of the plurality of air passages comprises the inlet and the outlet.

7. The vehicle of claim 6 wherein the plurality of air passages is disposed laterally.

8. The vehicle of claim 6 wherein the plurality of air passages is disposed longitudinally.

9. The vehicle of claim 1 wherein the outer surface and the inner surface are formed of metal.

10. The vehicle of claim 9 wherein the outer surface and the inner surface are electro-coated.

11. The vehicle of claim 1 wherein the outer surface is formed of metal and the inner surface is formed of a composite material.

12. The vehicle of claim 11 wherein the inner surface is a unitary structure coupled to the outer surface.

13. The vehicle of claim 12 wherein the unitary structure comprises the inlet and the outlet.

14. The vehicle of claim 13 wherein the unitary structure comprises a sealing surface.

15. The vehicle of claim 12 wherein the unitary structure comprises a plurality of inlets and a plurality of outlets.

16. The vehicle of claim 15 wherein the plurality of inlets and the plurality of outlets are laterally disposed relative to the vehicle.

17. The vehicle of claim 15 wherein the plurality of inlets is elongated and disposed laterally relative to the vehicle.

18. The vehicle of claim 15 wherein the plurality of outlets is elongated and disposed laterally relative to the vehicle.

19. The vehicle of claim 1 wherein the front trunk door comprises a sealing surface adjacent to the seal.
